(19) United States
(12) Patent Application Publication
(10) Pub. No.: US 2026/0312990 A1
(43) Pub. Date: Oct. 8, 2026

(54) Systems and Methods of Using Language Models for Combating Online Fraud

(71) Applicant: Bitdefender IPR Management Ltd., Nicosia (CY)

(72) Inventors: Ovidiu L. CRISTINA, Ghiroda (RO); Razvan G. GOSA, Bumbesti-Jiu (RO); Marius M. TIVADAR, Baia Mare (RO)

(21) Appl. No.: 19/098,201

(22) Filed: Apr. 2, 2025

(51) Int. Cl. H04L 9/40; G06F 40/284

(52) U.S. Cl. CPC H04L 63/1483; G06F 40/284

(57) ABSTRACT

Embodiments enable an efficient detection of online fraud such as fishing, among others. A relatively small client-side language model (LM) computes a compact message embedding characterizing a message received by the respective client device. The compact message embedding is transmitted to a security server, where it is inflated and fed to a large server-side LM. The size of the client- and server-side LMs may differ by orders of magnitude. The server-side LM is tasked with identifying fraudulent messages and/or determining various attributes of the respective message. Transmitting a message embedding to the server instead of the message itself ensures the privacy of the user. Meanwhile, using a relatively small LM makes it possible to perform LM-assisted feature extraction on a client device with modest computing resources, such as a mobile telephone.

### BACKGROUND OF THE INVENTION

The invention relates to computer security, and in particular to combating online fraud such as phishing, among others.

Online fraud, especially in the form of phishing and identity theft, has been posing an increasing threat to Internet users worldwide. Sensitive identity information such as user names, IDs, passwords, social security and medical records, bank and credit card details obtained fraudulently by international criminal networks operating on the Internet are used to withdraw private funds and/or are further sold to third parties. Beside direct financial damage to individuals, online fraud also causes a range on unwanted side effects, such as increased security costs for companies, higher retail prices and banking fees, declining stock values, lower wages and decreased tax revenue.

Online fraud is facilitated by the explosive growth of mobile computing and online services, with millions of devices such as smartphones and tablet computers constantly connected to the Internet and acting as potential targets. In a typical example of phishing, a user receives a fraudulent communication masquerading as a legitimate message from a service provider such as a bank, phone company, online retailer, courier, etc. The message may report a fictitious problem affecting the user's account or recent order and invite the user to contact the respective service provider via a link included in the respective message. The link may lead to a fake interface (e.g., webpage) used by online criminals to steal sensitive data such as login credentials and credit card numbers, among others. Accessing such links may further expose the user to a risk of installing malicious software.

Various methods of countering online fraud have been proposed. Security software can be used to detect fraudulent messages and alert the user. However, the content and format of fraudulent messages changes all the time, and the sheer volume of such messaging makes detection inherently difficult. The problem is further aggravated by the recent development of sophisticated language models capable of highly realistic fraudulent messaging. To counter such threats, security software itself increasingly relies on language models and other artificial intelligence (AI) means. However, training and operating high-performance language models typically consumes substantial computational resources, which makes their deployment to client devices such as mobile telephones and Internet of Things (IoT) devices currently impractical. Therefore, there is an ongoing interest in developing more robust and computationally-efficient methods of combating online fraud.

### SUMMARY OF THE INVENTION

According to one aspect, a server computer system carries out fraud detection activities on behalf of a plurality of client devices. The server computer system comprises at least one hardware processor configured to receive a compact message embedding from a client device of the plurality of client devices, the compact message embedding characterizing a natural language (NL) message received at the client device, the compact message embedding computed by a client-side language model (LM) pre-trained to identify fraudulent messages. The at least one hardware processor is further configured to inflate the compact message embedding to produce an inflated embedding substantially larger than the compact message embedding, and to input the inflated embedding to a selected component of a server-side LM executing on the server computer system, the server-side LM substantially larger than the client-side LM. The at least one hardware processor is further configured to determine whether the NL message is fraudulent according to an output of the server-side LM.

According to another aspect, a method of detecting fraudulent messages uses a server computer system connected to a plurality of client devices. The method comprises employing at least one hardware processor of the server computer system to receive a compact message embedding from a client device of the plurality of client devices, the compact message embedding characterizing a natural language (NL) message received at the client device, the compact message embedding computed by a client-side language model (LM) pre-trained to identify fraudulent messages. The method further comprises employing the at least one hardware processor to inflate the compact message embedding to produce an inflated embedding substantially larger than the compact message embedding, and to input the inflated embedding to a selected component of a server-side LM executing on the server computer system, the server-side LM substantially larger than the client-side LM. The method further comprises employing the at least one hardware processor to determine whether the NL message is fraudulent according to an output of the server-side LM.

According to another aspect, a non-transitory computer-readable medium stores instructions which, when executed by at least one hardware processor of a server computer system connected to a plurality of client devices, cause the computer system to receive a compact message embedding from a client device of the plurality of client devices, the compact message embedding characterizing a natural language (NL) message received at the client device, the compact message embedding computed by a client-side language model (LM) pre-trained to identify fraudulent messages. The instructions further cause the computer system to inflate the compact message embedding to produce an inflated embedding substantially larger than the compact message embedding, and to input the inflated embedding to a selected component of a server-side LM executing on the server computer system, the server-side LM substantially larger than the client-side LM. The instructions further cause the computer system to determine whether the NL message is fraudulent according to an output of the server-side LM.

### BRIEF DESCRIPTION OF DRAWINGS

The foregoing aspects and advantages of the present invention will become better understood upon reading the following detailed description and upon reference to the drawings where:

FIG. 1 shows a fraud prevention system protecting an exemplary client device according to some embodiments of the present invention.

FIG. 2 shows exemplary components of a protected client device according to some embodiments of the present invention.

FIG. 3 illustrates the exemplary components and operation of a client-side security agent according to some embodiments of the present invention.

FIG. 4 illustrates the operation of an exemplary generative language model (GLM) according to some embodiments of the present invention.

FIG. 5 shows exemplary components of a language model according to some embodiments of the present invention.

FIG. 6 shows exemplary components of a feature extractor executing on the client device according to some embodiments of the present invention.

FIG. 7 shows an exemplary message digest comprising a plurality of message feature values according to some embodiments of the present invention.

FIG. 8 illustrates training of the client-side LM according to some embodiments of the present invention.

FIG. 9 shows exemplary components a security server according to some embodiments of the present invention.

FIG. 10-A shows an exemplary architecture and operation of a server-side LM according to some embodiments of the present invention.

FIG. 10-B shows an alternative exemplary architecture and operation of the server-side LM according to some embodiments of the present invention.

FIG. 11 illustrates an exemplary inflator according to some embodiments of the present invention.

FIG. 12 shows training the server-side LM according to some embodiments of the present invention.

FIG. 13 illustrates an exemplary co-training of the client- and server-side LMs according to some embodiments of the present invention.

FIG. 14 shows an exemplary sequence of steps carried out by the client-side security agent according to some embodiments of the present invention.

FIG. 15 shows an exemplary sequence of steps performed by the security server according to some embodiments of the present invention.

FIG. 16 shows an exemplary hardware configuration of a computer system programmed to execute some of the methods described herein.

### DETAILED DESCRIPTION OF THE INVENTION

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Any use of ‘or’ is meant as a nonexclusive or. Unless otherwise required, any described method steps need not be necessarily performed in a particular illustrated order. A first element (e.g., data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. A computer program is a sequence of processor instructions carrying out a task. Computer programs described in some embodiments of the present invention may be stand-alone software entities or sub-entities (e.g., subroutines, libraries) of other computer programs. A database or knowledgebase herein denotes any organized, searchable collection of data. The size of a data structure such as a vector, matrix, or tensor herein denotes a count of elements of the respective data structure. A size of a language model herein denotes a count of parameters of the respective language model, parameters which can be adjusted by training. A first object is herein said to be substantially larger than a second object when the first object is at least twice the size of the second object. Computer-readable media encompass non-transitory media such as magnetic, optic, and semiconductor storage media (e.g., hard drives, optical disks, flash memory, DRAM), as well as communication links such as conductive cables and fiber optic links. According to some embodiments, the present invention provides, inter alia, computer systems comprising hardware (e.g., one or more processors) programmed to perform the methods described herein, as well as computer-readable media encoding instructions to perform the methods described herein.

The following description illustrates embodiments of the invention by way of example and not necessarily by way of limitation.

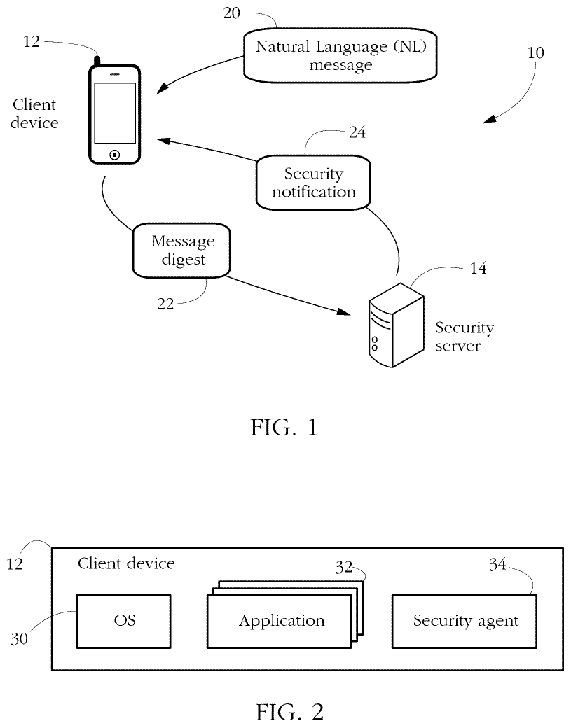

FIG. 1 shows a fraud prevention system 10 protecting an exemplary client device 12 according to some embodiments of the present invention. Client device 12 generically represents any electronic device comprising a hardware processor, a memory, and a communication interface enabling device 12 to communicate with other devices/computer systems. Exemplary client devices 12 include personal computer systems, mobile computing platforms (e.g., laptop computers, tablets, smartphones), entertainment devices (e.g., TVs, game consoles), wearable devices (e.g., smartwatches, fitness bands), and household appliances (e.g., thermostats, refrigerators), among others.

In some embodiments, client device 12 collaborates with a security server 14 to protect a user against online fraud. Server 14 herein generically represents a set of communicatively coupled computer systems, which may or may not be in physical proximity to each other. A single instance of server 14 may protect multiple client devices 12. Such protection may pe tailored to each device, device group, user, or user group, and various parameters of the respective protection service may be defined via a subscription/service agreement, etc.

Client device 12 communicates with server 14 and other parties via a communication network, which may include a local area network (e.g., home network, corporate network, etc.), a wide-area network, and/or the Internet. The respective networks include a set of hardware (physical layer) and software interfaces enabling the transfer of data between client device 12 and server 14, among others.

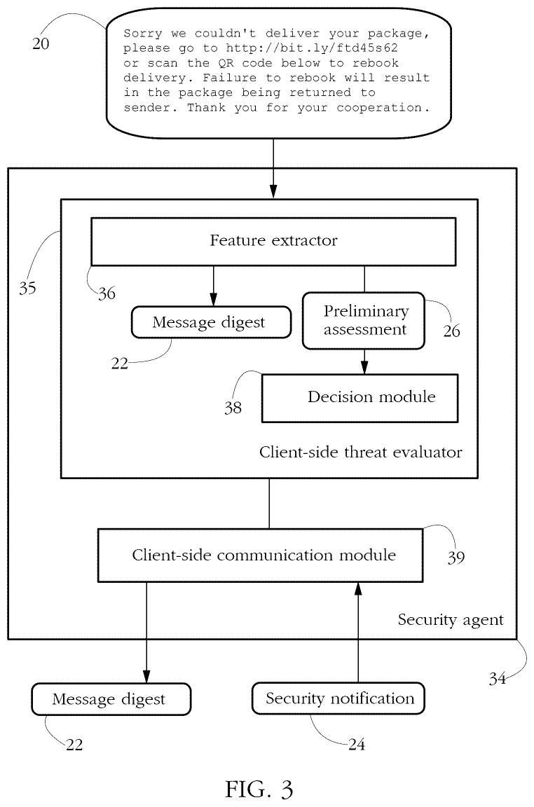

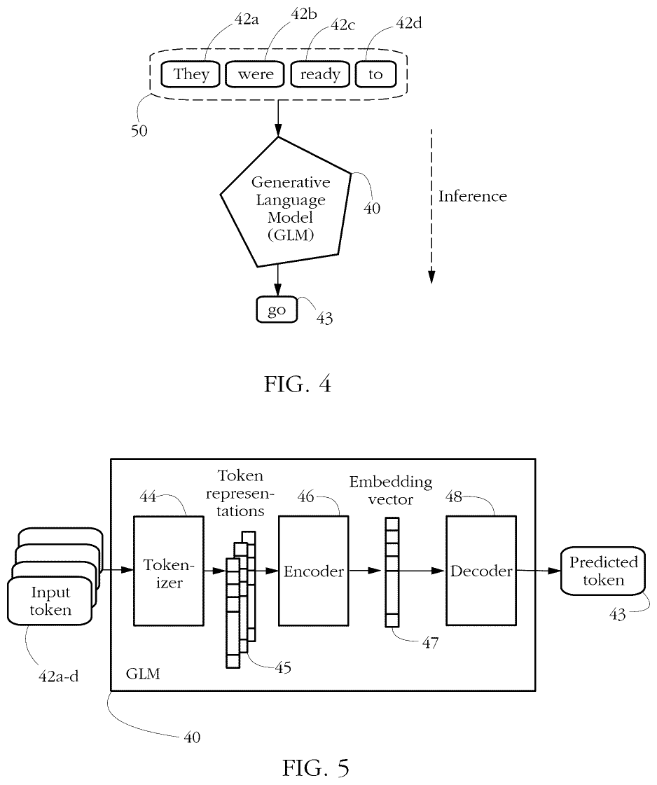

In some embodiments as illustrated, client device 12 receives a natural language (NL) message 20 comprising a computer encoding of a message formulated in a natural human language such as English and Chinese, among others. See e.g., exemplary message 20 in FIG. 3. NL message 20 is typically received and processed by dedicated electronic communication software (e.g., messaging app) executing on client device 12. NL messages herein encompass peer-to-peer messages as well as messages exchanged via public chatrooms, forums, social media sites, etc. Some examples of NL messages 20 include short message service (SMS) messages, e-mail messages, and messages exchanged via instant messaging applications such as WhatsApp Messenger®, Telegram®, WeChat®, and Facebook® Messenger®, among others. Other exemplary NL messages 20 include a content of a Facebook® wall, a message posted on an online forum such as Reddit® and Discord®, and a blog post, among others.

NL messages 20 may vary in format according to the respective messaging platform, protocol, and/or application, but in general they comprise an encoding of a text and/or an encoding of a media file (e.g., image, movie, sound, etc.). The text part may comprise text written in a natural language, as well as other alphanumeric and/or special characters such as emoticons, among others. NL message 20 may further include various metadata such as identifiers of a sender and receiver of the respective message and a timestamp indicative of a time of transmission of the respective message.

For clarity, the following description will focus on processing text formulated in a natural language. However, a skilled artisan will know that the systems and methods described herein can be adapted to other types of content and media, for instance, an audio message (e.g., spoken conversation), an image of a text fragment, a video message, or any combination thereof. Such alternative embodiments may use AI models pre-trained on the respective type of medium, or translate the respective message into text (e.g., via optical character recognition-OCR, speech-to-text technologies, etc.) before applying the methods described herein.

In some embodiments as illustrated, client device 12 transmits a message digest 22 characterizing received NL message 20 to server 14. In turn, security server 14 analyzes message digest 22 returns a security notification 24 to client device 12, notification 24 indicating whether NL message 20 is indicative of a threat, for instance whether message 20 is fraudulent.

FIG. 2 shows exemplary components of client device 12, at least some of which may be embodied as computer programs (software) executing on a hardware processor of device 12. An operating system 30 forms an interface between application software and the hardware (e.g., processor, I/O devices, etc.) of the respective client. Popular examples of OS 30 include a version of Microsoft Windows®, iOS®, and Android®, among others.

Applications 32 generically represent any software installed on client device 12, such as productivity applications, utilities, games, browser, social media, and messaging/communication applications (e.g., software implementing an SMS service on a mobile phone, an email client, an instant messaging application such as WhatsApp Messenger®, etc.), among others. A security agent 34, which may also be embodied as a set of interconnected computer programs, is configured to protect client device 12 against online fraud. Agent 34 may form a part of a larger software suite protecting device 12 against other computer security threats such as malware, unsolicited communications (spam), etc., and/or enabling confidential communications with other parties (e.g., via virtual private networking-VPN).

Agent 34 may access NL message 20 using any method known in the art. With the agreement of a user of client device 12, some embodiments install a data grabber module (for instance, a plugin or add-on) within a local messaging application 32. Such addition may even be performed without the knowledge of the user, for instance by hooking a component of the respective messaging application, thus redirecting execution to the data grabber module. The data grabber may then notify security agent 34 when the messaging application executes some specific operation such as receiving a communication or receiving user input, enabling the extraction of message data. Yet other exemplary embodiments extract message content using built-in features of OS 30, such as an accessibility application programming interface (API). Accessibility APIs comprise software typically configured to grab information currently displayed on an output device (e.g., screen) of client device 12 for the purpose of making such information accessible to people with disabilities. One exemplary application of such accessibility APIs comprises translating on-screen text into audio (spoken text) to enable visually impaired people to use the computer. Some embodiments of security agent 34 may be configured to call specific accessibility API functions to parse data structures such as user interface (UI) trees while device 12 is displaying content generated by the messaging application, thus extracting message data and/or metadata.

Another category of methods for accessing message content comprise agent 34 directly intercepting network traffic going into the respective messaging application and/or traversing a network adapter of client device 12. Such interceptors may implement communication protocols such as HTTP, WebSocket, and MQTT, among others, to parse communications and extract structured message data. When NL messages 20 are encrypted, some embodiments may employ techniques such as man-in-the-middle (MITM) to decrypt traffic for message content extraction. Yet other exemplary embodiments may intercept and access messages before they reach their intended destination (client device 12). Such interception may occur on a messaging server (e.g., email server) or on a gateway device enabling client device 12 to access an extended network such as the Internet.

FIG. 3 shows exemplary components of security agent 34 according to some embodiments of the present invention. Agent 34 comprises a client-side threat evaluator 35 coupled to a client-side communication module 39. Threat evaluator 35 is configured to receive NL message 20 and to determine message digest 22 according to message 20. Communication module 39 transmits message digest 22 to security server 14 and receives security notification 24 from server 14. The operation of client-side threat evaluator 35 is described in further detail below.

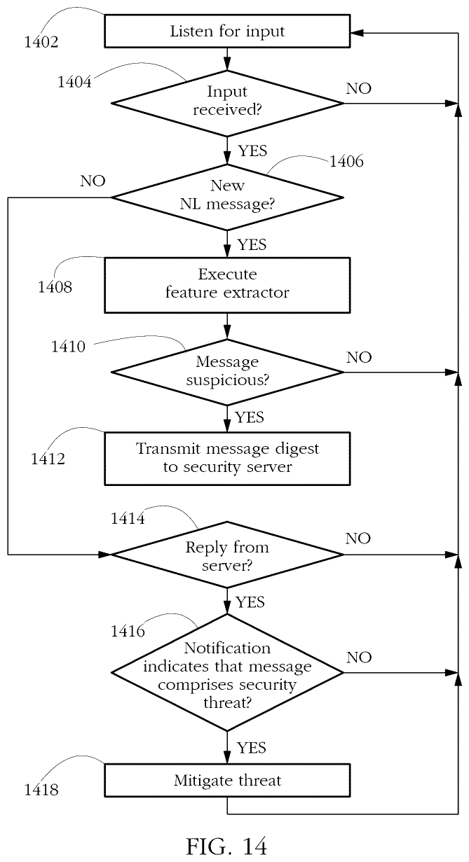

In some embodiments, client-side threat evaluator 35 further includes a feature extractor 36 connected to a decision module 38. Feature extractor 36 is configured to determine a set of feature values characterizing NL message 20, and to further construct message digest 22 according to the determined feature values. Some embodiments of feature extractor 36 further output a preliminary assessment 26 of NL message 20, comprising a set of message features indicative of whether message 20 exposes a user of client device 12 to a computer security threat, such as online fraud. An exemplary assessment 26 may indicate for instance if message 20 is fraudulent, or if message 20 requires urgent action from the user. In another example, assessment indicator 26 includes a set of class or category indicators, each such indicator indicative of whether the respective message belongs to a pre-determined class or category (e.g., parcel delivery, promotional offers, online banking, etc.). In yet another example, assessment indicator 26 includes an identifier of a natural language (e.g., English, Spanish) of message 20. In some embodiments, decision module 38 determines according to preliminary assessment 26 whether to transmit message digest 22 to server 14, as further described below in relation to FIG. 14.

An exemplary message digest 22 according to some embodiments of the present invention is illustrated in FIG. 7. A skilled artisan will know that the illustrated data structure is only exemplary and not meant to be limiting. Exemplary digest 22 comprises an identifier of a message and/or an identifier of a client device having received the respective message. Unique identifiers may be generated using any method known in the art, e.g., by hashing. Digest 22 further includes a plurality of feature values fᵢ, each such feature value comprising a value of a selected feature/attribute Fᵢ of the respective message. The count of such attributes Fᵢ may vary among embodiments, but typically it is of the order of several tens to several thousands. Some attributes may be fraud-indicative, either intrinsically or in combination with other features. Values fᵢ may be numbers, Booleans, character strings, or of any other data type according to the type of the respective feature Fᵢ.

Some exemplary feature values fᵢ included in message digest 22 are determined according to various metadata attached to the respective message, such as an identifier (e.g., name, alias, username, handle, email address, network address, phone number) of a sender of the respective message, a country code of the receiving client, a time stamp, and a type of media attached to or embedded into the respective message, among others.

Other message features Fᵢ characterize the content of a message (e.g., a text part). One such exemplary content feature comprises at least a part of the message text. Other examples of content features include indicators of whether the respective message contains a pre-determined keyword/phrase (e.g., login, bank, package, phone bill, specific company names, specific brand names), whether the respective message includes a hyperlink, whether the respective message includes an ID (e.g., personal name, email address, social media handle, login credentials), etc. Other content features may comprise a size of the text (e.g., count of characters) and an indicator of a visual layout of the message.

Some embodiments of feature extractor 36 use a language model to compute content feature values fᵢ characterizing NL message 20. A language model (LM) herein denotes any implementation of a computational model of a natural language such as English or Chinese, among others. Exemplary language models include probabilistic n-gram models, LMs implemented using recurrent neural networks, and large language models (LLMs) implemented using generative pre-trained transformers (GPT), among others. Some language models are herein deemed ‘generative’ in the sense that they are configured to input a sequence of words (e.g., a sentence or a question) and in response, automatically generate another sequence of words (e.g., a plausible continuation or a reply) according to the input word sequence. Examples include any instance of a pre-trained, off-the-shelf LLM such as GPT4 from OpenAI, LLAMA from Meta AI, and Mistral from Mistral AI, among others.

An exemplary generative language model (GLM) 40 according to some embodiments of the present invention is illustrated in FIG. 4. GLM 40 is configured to receive a language model prompt 50 comprising a sequence of tokens 42a-d, and in response, output a predicted token 47 determined according to the received LM prompt, predicted token 43 comprising a likely continuation of the sequence of tokens 42a-d. The set of calculations carried out by GLM 40 to produce an individual predicted token are herein collectively called an inference. When the architecture of GLM 40 is based on neural networks, such calculations may comprise matrix multiplications and evaluating a set of activation functions, among others.

Exemplary tokens 42a-d and 43 may comprise individual words, but also numbers, punctuation marks, special characters, abbreviations, initialisms (e.g., LOL, ROFL), emojis, as well as network addresses, universal record identifiers (URI) and locators (URL), among others. Some tokens may include multiple words such as phrases, etc. Some GLMs 40 can also ingest content other than natural language text, such as fragments of computer code. For instance, individual tokens 42a-d and 43 may include computer instructions, variable names and values, mathematical symbols, etc.

FIG. 5 further shows a structural diagram of GLM 40 according to some embodiments of the present invention. GLM 40 comprises a stack of interconnected neural layers, each layer receiving input from the previous layer and feeding the next layer of the stack. Functionally, the layer stack may be broken down into a first subset of layers collectively forming a tokenizer 44, a second subset of layers collectively forming a encoder 46, and a third set of layers forming a decoder 48.

Tokenizer 44 receives prompt 50 and calculates a set of token representations 45 typically comprising a vector of numerical values for each input token 42a-d. Token representations 45 are token-specific and may include a position encoding indicative of a position of each token 42a-d within prompt 50. The size of token representations 45 varies among models, but is typically of the order of a few hundred to a few thousand elements for each input token 42a-d. Encoder 46 receives token representations 45 and outputs an embedding vector 47 comprising a set of numbers collectively amounting to an internal representation of input prompt 50. In some embodiments, embedding vector 47 comprises a projection of prompt 50 into a multidimensional abstract space wherein prompts 50 that are semantically similar are located relatively close together. Decoder 48 then determines predicted token 43 according to the received embedding vector 47. Additionally or alternatively, in some embodiments decoder 48 may determine various features of input prompt 50, for instance classify prompt 50 into one of a plurality of pre-determined categories (e.g., fraudulent vs. benign), determine a topic or a sentiment of prompt 50, etc.

The architectural and operational details of modules 44-46-48 vary among models and go significantly beyond the scope of the present invention. They may implement any method and language model architecture known in the art. The operation of each module 44-46-48 typically comprises a sequence of matrix multiplications and evaluations of activation functions, the parameters of which are pre-determined by training GLM 40 on a corpus of text. Overall, the count of adjustable parameters included in a typical GLM varies from a few million to hundreds of billions, making the training and operation of GLMs relatively expensive in terms of processor cycles and memory and therefore impractical for client devices with limited resources such as mobile telephones and Internet of Things (IoT) devices.

Some embodiments of the present invention explicitly address such shortcomings by dividing the computational burden of using GLMs between client device 12 and security server 14. In some embodiments as described in detail below, feature extractor 36 executing on client device 12 uses a lightweight LM to determine a compact message digest characterizing the respective message, then transmits the message digest to a substantially larger LM executing on server 14, for further processing.

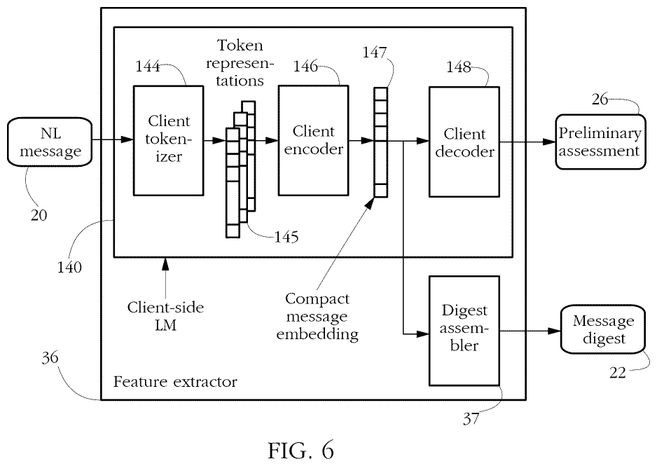

Exemplary components of feature extractor 36 according to some embodiments are illustrated in FIG. 6. A client-side LM 140 is coupled to a digest assembler 37. LM 140 further includes a client tokenizer 144, a client encoder 146 and a client decoder 148. Tokenizer 144 computes token representations 145 for each token of NL message 20. Typical token representations 145 comprise vectors having anywhere in the range of 128 to 512 elements of type float. Client encoder 146 may comprise, for instance, a set of attention blocks, and is configured to compute a compact message embedding 47 according to token representations 145. Embedding 47 thus comprises a vector of values collectively encoding the semantics of NL message 20. The size of compact embedding 47 is deliberately chosen to be substantially smaller than typically produced by a large language model (LLM), while being large enough to still preserve the capability to distinguish between messages with different semantics, for instance between fraudulent and benign messages. In typical embodiments, the size of compact embedding 47 ranges from 128 to 1024 elements. A client decoder 148 determines preliminary assessment 26 according to an output of client encoder 146.

Digest assembler 37 computes and formats message digest 22 according to compact message embedding 47. In some embodiments as illustrated in FIG. 7, at least a part of message digest 22 includes elements of compact message embedding 47 and/or selected feature values fᵢ determined according to elements of embedding 47. Digest assembler 37 may further compute other feature values fₖ₊₁ . . . f_{M} comprising values of other message features, e.g., message metadata and any other fraud-indicative features known in the art.

In some embodiments, parameters of client-side LM 140 are determined via a training process. Training an AI system herein denotes tuning adjustable parameters of the AI system according to an output produced by the respective AI system in response to a set of training inputs. An instance of client-side LM 140 may be pre-trained on a large corpus of natural language text, aiming at developing language and semantic proficiency. In some such embodiments, the tokenizer, encoder, and/or decoder modules may be adapted from an off-the-shelf, pre-trained LM such as a reduced version of a LLaMA model from Meta, Inc. The client-side LM may then follow specialized training aimed at evaluating message features Fⱼ.

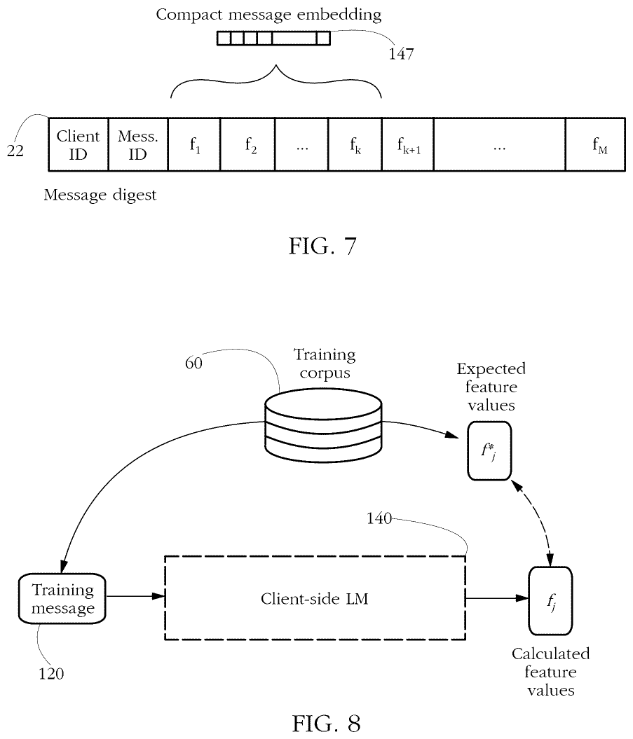

An exemplary system for specialized training of client-side LM 140 is illustrated in FIG. 8. A training corpus 60 comprises a collection of training messages 120, each message annotated with a set of pre-determined expected feature values {f*ⱼ}, representing values of various features Fⱼ of the respective training message, for instance, features indicating whether the respective message is fraudulent, whether a respective message belongs to a pre-determined category of content, an indicator of a sentiment of the respective message, etc. Specialized training of client-side LM 140 may comprise presenting each training message 120 to client tokenizer 144, employing modules 144, 146, and 148 to compute message features {fⱼ} according to the respective training message, and then adjusting parameters of modules 144, 146, and/or 148 according to the computed output, the adjustment directed at reducing discrepancies between computed feature values {fⱼ} and expected feature values {f*ⱼ}. Training may implement any algorithm known in the art, such as steepest descent or a version of a genetic algorithm, among others.

Some embodiments rely on the observation that to divide LM activities between the client and server, message digest 22 should encode information relevant to the task of the server-side LM. For example, when said task comprises detecting fraudulent messages, digest 22 should encode as much fraud-related information as possible. One way to force a language model to encode task-specific information is to train the respective model on the respective task. Following such task-specific training, internal representations of the analyzed object, such as embedding vector 47 in FIG. 5, are more likely to encode information relevant to the respective task. In light of this observation, some embodiments explicitly train client-side LM 140 to carry out at least some of the tasks assigned to the server-side language model, for instance to evaluate the same message features Fⱼ as the server-side LM.

In an exemplary fraud-detecting embodiment, modules 144, 146, and/or 148 are specialized-trained on a corpus of training messages 120 pre-labeled as fraudulent or not. Stated otherwise, expected feature value(s) f*ⱼ may be indicative of fraud. In some embodiments, specialized training is applied selectively, for instance only to encoder 146 and/or decoder 148, leaving tokenizer 144 intact. Such selective training may better preserve the linguistic competence of the respective LM, especially in the case of specific tasks and training corpora.

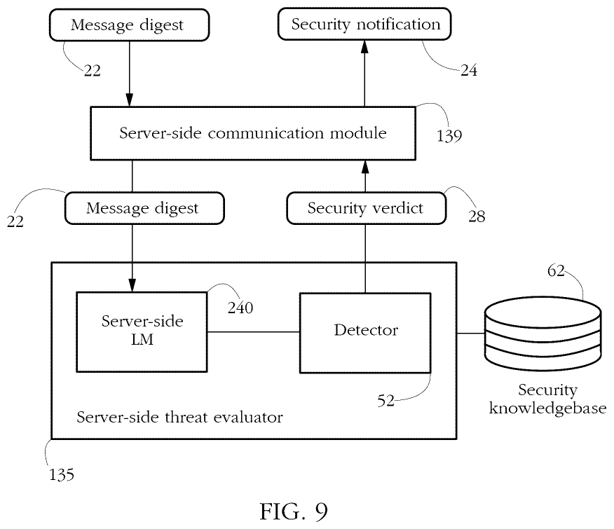

FIG. 9 shows exemplary components of security server 14 according to some embodiments of the present invention. At least some of the illustrated components may be implemented in software (computer programs) executing on at least one hardware processor of server 14. A server-side communication module 139 receives message digests 22 from clients and further transmits digest 22 to a server-side threat evaluator 135 comprising a server-side LM 240 coupled to a detector 52. LM 240 collaborates with detector 52 in formulating a security verdict 28 indicating whether the message characterized by digest 22 exposes a user to a computer security threat (e.g., online fraud). Communication module 139 then formulates security notification 24 according to verdict 28 and selectively transmits notification 24 to a respective client device.

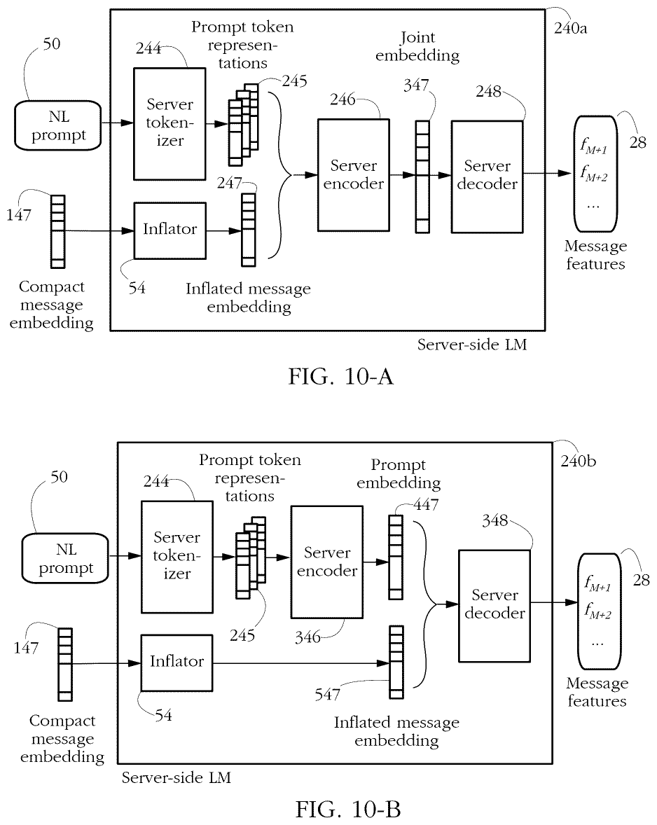

FIGS. 10-A-B show exemplary alternative configurations of a server-side LM according to some embodiments of the present invention. Components of server-side LMs 240a-b may include a tokenizer, an encoder, and a decoder, the structure and operation of which largely follow the description above relative to FIGS. 5 and 8, among others. A respective tokenizer determines numerical representations (e.g., vectors of numbers) for each of a sequence of natural language tokens, such as individual words. A respective encoder determines an internal representation of the NL token sequence in the form of an embedding (e.g., again a vector of numbers). A respective decoder then computes a set of output values (e.g., a sequence of NL tokens, a value of a selected feature of the input token sequence).

In some embodiments, the size of server-side LMs 240a-b expressed, for instance, as a count of parameters or a computational cost of running, substantially exceeds that of client-side LM 140 (e.g., FIG. 6). Some embodiments rely on the observation that computational resources of security server 14 may vastly exceed those of a typical client device such as a mobile telephone, for example. This allows some embodiments to use a large language model on the server side, thus benefitting from the language and semantic proficiency of LLMs. In exemplary embodiments, server-side LMs 240a-b may include a modified version of a commercial LLM, such as a member of the GPT family of LLMs OpenAI, or a member of the LLAMA family from Meta, Inc. In such embodiments, the size of server-side LMs 240a-b may exceed that of client-side LM 140 by at least one order of magnitude.

Server-side LMs 240a-b receive compact message embedding 147 and an NL prompt 50 and output a set of message feature values 28. Compact message embedding 147 is extracted from or otherwise determined according to message digest 22 characterizing an NL message received by a client device 12 (see FIG. 7 above). Feature values 28 may include values of any feature characterizing the respective NL message. Some feature values 28 may indicate whether the respective message is fraudulent, whether it is indicative of a particular type of threat (e.g., phishing, malware, unauthorized intrusion), etc. Other feature values 28 may indicate whether the respective message belongs to a predetermined category of messages (e.g., personal, parcel delivery, banking, calendar notification, etc.). Yet other exemplary features extracted at server 14 may include a natural language of the respective message, a set of keywords included in the respective message, and a summary of the respective message, among others.

NL prompt 50 may instruct LMs 240a-b to determine feature values 28. For instance, when a selected feature value fᵢ indicates whether the respective message is fraudulent, as associated NL prompt may read “Determine whether the following message is fraudulent” or a similar question or statement. Other examples of NL prompts 50 include: “What is the sentiment of the following message?”, “Does the following message include a company name? If yes, what type of company (telecom, courier services, etc.)?”, “Does the sender of this message expect a response?”, “What language is the following message in?”, “Extract 5 keywords characterizing the following message”, and “Summarize the following message”, among others. An artisan will know that these are only examples and not meant to be limiting.

NL prompts 50 may further include feature-specific context usable by LMs 240a-b to compute a respective feature value. An exemplary prompt context may read “The following message was received via SMS by a user from Germany on Mar. 20, 2025.”

In some embodiments, NL prompts 50 are pre-defined and stored in a repository, for instance part of a security knowledgebase 62 (FIG. 9) communicatively coupled to security server 14. Alternatively or additionally, some NL prompts 50 may be generated dynamically, for instance according to an output of LMs 240a-b produced in response to a previous NL prompt. One substantial technical advantage of interacting with LMs 240a-b via prompts is that NL prompts 50 and at least some of the respective message features may be updated independently of internal components of LMs 240a-b. Stated otherwise, a determination of a new message feature may not require structural changes or re-training the respective server-side LM, but may be achieved simply by formulating a new NL prompt.

A skilled artisan will also know that LMs 240a-b may output feature values 28 directly or indirectly. In one example of indirect output, LM 240a may be configured to output natural language text, for instance a response to a question included in NL prompt 50. Some embodiments may then employ an additional component, such as a text parser, to extract or otherwise determine a respective feature value fᵢ according to the output of LM 240a.

Exemplary server-side LM 240a (FIG. 10-A) comprises a server tokenizer 244 configured to determine a set of token representations 245 comprising numerical representations of tokens of NL prompt 50. A server encoder 246 coupled to tokenizer 244 determines an embedding vector 347 according to prompt token representations 245. In turn, a server decoder 248 is configured to determine feature values 28 according to an output of encoder 248.

In some embodiments as illustrated, server encoder 246 is configured to determine embedding vector 347 further according to compact message embedding 147. In such embodiments, vector 347 is herein deemed a joint embedding since it encodes both NL prompt 50 and NL message 20 (via compact embedding 147). There may be various manners of configuring encoder 247 to accept data characterizing NL message 20. In one example, compact message embedding 147 is transformed to resemble prompt token representations 245, i.e., representations of individual tokens of NL prompt 50. Encoder 246 may then receive the transformed message embedding just as it would any other token representation. Such embodiments have the advantage of requiring only minimal modifications of a standard, off-the shelf, pre-trained LLM.

In embodiments as illustrated in FIG. 10-A, an inflator module 54 may inflate compact embedding 147 to produce an inflated message embedding 247 matching the size and/or format of individual prompt token representations 245. In typical embodiments wherein the size of server-side LM 240a-b exceeds that of client-side LM 140 by orders of magnitude, inflated message embedding 247 may be substantially larger (e.g., have at least twice the number of elements) than compact embedding 147. For instance, a typical inflated embedding 247 may have 2048 to 4096 elements.

Inflating an object herein denotes transforming said object to increase its size. In the case of a vector or matrix, inflation denotes increasing the count of elements of the respective vector or matrix. An artisan will know that depending on the type of data structure, inflation may further require reformatting, data type conversion, and/or addition of metadata. Exemplary methods of inflating compact embedding 147 include inserting dummy elements such as zeroes or other pre-defined constants at either end or in between elements of the respective object.

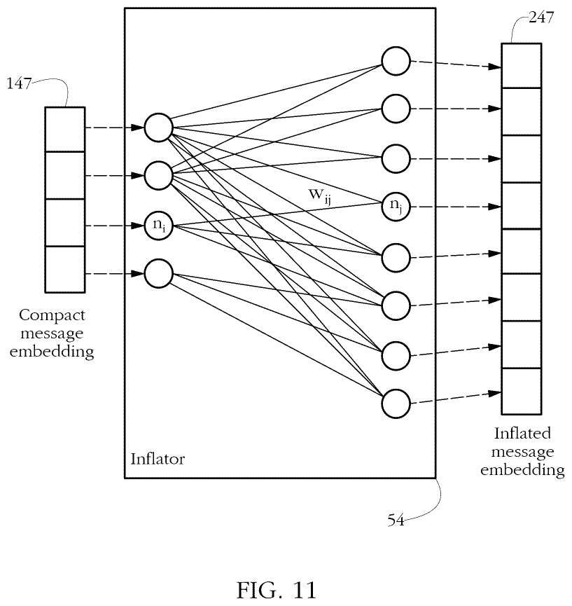

In a preferred embodiment, inflator 54 comprises an artificial neural network having a stack of neural layers as illustrated in FIG. 11, each layer receiving input from the previous one and feeding the following layer of the stack. An artisan will know that even though FIG. 11 only shows two layers of neurons, the figure is merely exemplary and can be easily adapted to an architecture with more than two layers. A first layer comprises a count of neurons that matches the size of compact message embedding 147, while the last layer comprises a count of neurons matching the size of inflated message embedding 247. Each neuron nᵢ in the input layer receives an individual element of compact embedding 147. Meanwhile, each neuron nⱼ of the output layer computes an individual element of inflated embedding 247. Neurons in consecutive layers are connected as illustrated, with the strength of a connection between neurons nᵢ and nⱼ denoted by a weight wᵢⱼ. Each neuron may therefore compute an output according to inputs received from multiple other neurons located in a previous layer, each individual contribution modulated by a respective inter-neuronal weight. Weights wᵢⱼ may be determined alongside other parameters of server-side LM 240 by a process of specialized training, as described in more detail below.

FIG. 10-B illustrates an alternative exemplary embodiment of server-side LM, wherein a server encoder 346 receives prompt token representations 245 determined by server tokenizer 244 for tokens of NL prompt 50 and outputs a prompt embedding 447 determined according to token representations 245. A server decoder 348 then determines feature values 28 according to the output of encoder 346. Inflator module 54 determines an inflated message embedding 547 by inflating compact message embedding 147, wherein said inflating may comprise zero-padding, upscaling, and/or passing embedding 147 through a stack of neural network layers as described above, resulting in resizing and/or otherwise re-formatting compact message embedding 147 to a substantially larger data structure. For instance, in typical embodiments, inflated embedding 547 has at least twice the number of elements (e.g., 2048 to 4096) as compact embedding 147.

In contrast to the embodiment illustrated in FIG. 10-A, in LM 240b the inflated message embedding is fed not to the encoder, but to the decoder. Stated otherwise, server decoder 348 is configured to receive both a prompt embedding 447 (comprising an embedding vector determined by encoder 346 according to NL prompt 50) and inflated message embedding 547.

In an exemplary embodiment according to FIG. 10-B, inflated message embedding 547 has the same size and format as prompt embedding 447 (i.e., matching the size of the output of encoder 346). Decoder 348 may then regard inflated message embedding 547 as any other embedding vector. One advantage of such a configuration is that it requires only minimal modifications to an off-the-shelf pre-trained LLM. In some embodiments, server-side decoder 348 may determine feature values 28 according to an aggregate input combining embeddings 447 and 547. For instance, some embodiments may determine a weighted sum between vectors 447 and 547, and feed the respective weighted sum to decoder 346:

$$I = {α}_{1} {E}_{1} + {α}_{2} {E}_{2} , \qquad [ 1 ]$$

wherein I denotes the input to decoder 348, E₁ and E₂ denote embeddings 447 and 547, respectively, and α₁ and α₂ are numerical weights adjusted, for instance, so that the contribution of prompt embedding 447 to I is substantially larger than that of inflated message embedding 547.

In some embodiments, parameters of server-side LM 240 are determined via training. An instance of the server-side LM may be pre-trained on a large corpus of natural language text, aiming at developing language and semantic proficiency. In some such embodiments, the tokenizer, encoder, and/or decoder modules may be adapted from an off-the-shelf, pre-trained LLM such as a version of a LLaMA model from Meta, Inc. The instance of the server-side LM may then follow specialized training aimed at evaluating message features Fⱼ, for instance determining whether a message is fraudulent.

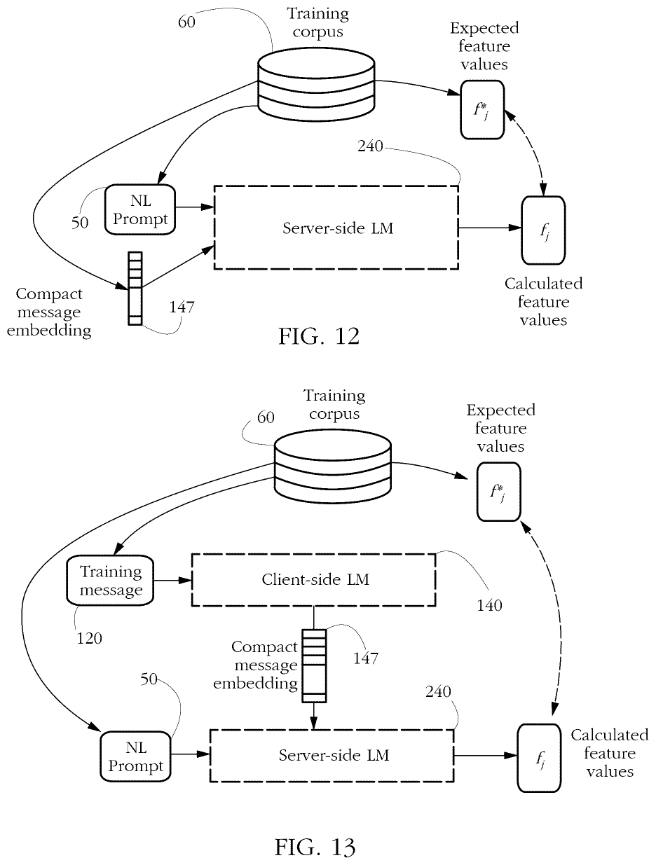

An exemplary system for specialized training of server-side LM 240 is illustrated in FIG. 12. For each training message 120 (see above in relation to FIG. 8), training corpus 60 may store a compact message embedding 147 characterizing the respective message and determined for instance by a trained instance of client-side LM 140. Training may comprise presenting each message embedding 147 to the trainee instance of server-side LM 240, employing inflator 54, server tokenizer, encoder, and decoder modules to compute message features {fⱼ} for the respective training message, and then adjusting parameters of inflator 54 and tokenizer, encoder and/or decoder modules according to the computed output, the adjustment directed at reducing discrepancies between computed feature values {fⱼ} and expected feature values {f*ⱼ}. Exemplary feature values fᵢ may indicate whether the respective message is fraudulent, whether the respective message belongs to a pre-determined category of messages (e.g., personal messages, package delivery messages, e-banking messages, etc.), etc. Training may implement any algorithm known in the art, such as steepest descent or a version of a genetic algorithm, among others.

In some embodiments, specialized training selectively applies only to some components of the server-side LM, for instance only to decoder modules 248 and 348 in FIGS. 10-A and 10-B, respectively. Leaving tokenizer and/or encoder modules untouched (i.e., in their pre-trained state achieved via language training) may preserve their language and semantic proficiency.

Some embodiments carry out a specialized co-training procedure wherein client-side LM 140 is trained together with server-side LMs 240. Co-training a pair of AI systems herein denotes adjusting parameters of one system according to an output of the other. FIG. 13 illustrates an exemplary co-training of client- and server-side LMs, wherein a trainee instance of client-side LM 140 is used to compute compact message embedding 147 for each training message 120. Embedding 147 is then fed to a trainee instance of server-side LM 240, which calculates message feature values fⱼ for each training message. A cost function may be determined according to calculated and expected feature values fⱼ and f*ⱼ, respectively. Parameters of the server- and client-side LM may then be adjusted according to the cost function, aiming at reducing differences between calculated and expected feature values. A skilled artisan will know that the present description may be adapted to other versions of co-training.

In some embodiments, detector 52 (FIG. 9) determines whether NL message 20 received by client device 12 exposes the user to a computer security threat, according to various features of message 20 included in message digest 22, as well as features determined by server-side LM 240. In determining security verdict 28, detector 52 may use any method known in the art of computer security. One exemplary family of methods of determining whether NL message 20 is fraudulent is to compare it against a collection of known fraudulent messages. Such comparison may be achieved for instance by clustering, a family of methods of grouping together messages according to a similarity of their features. Stated otherwise, when represented in an abstract multidimensional feature space, messages that share similar features are grouped together, forming a cluster. Distinct clusters may represent distinct families/categories/classes of messages. Known clustering methods include k-nearest neighbors, among others. In an exemplary embodiment using clustering, detector 52 may identify a cluster of messages most similar to NL message 20. When the identified cluster includes fraudulent messages, some embodiments may determine that the current NL message is itself fraudulent. Other exemplary methods of detecting computer security threats include a decision tree, wherein each branch is defined by a tuple of feature values {fᵢ} and some branches are associated with a threat such as online fraud. In yet another example, detector 52 may include an artificial neural network pre-trained to receive a tuple of feature values {fᵢ} characterizing NL message 20 and to output an indicator of a likelihood that the respective message is fraudulent.

FIG. 14 shows an exemplary sequence of steps performed by the client-side security agent 34 according to some embodiments of the present invention. A sequence of steps 1402-1404 listens for input, which may come either in the form of a new NL message or a verdict from security server 14. When the input comprises a new NL message, a step 1408 may execute feature extractor 36 to determine message digest 22 and preliminary assessment 26 (see e.g., FIG. 6). An exemplary preliminary assessment 26 may indicate whether NL message 22 is suspicious of a computer security threat such as online fraud. Alternatively or additionally, preliminary assessment 26 may indicate whether NL message 22 requires an urgent reaction from a user of client device 12, relying on the observation that online fraud often relies on creating a sense of urgency, such as formulating NL message 20 as a limited time offer or a similar time-sensitive proposition.

To reduce traffic and the load on server 14, some embodiments only inquire server 14 when preliminary assessment 26 indicates a suspicious message and/or one that requires an urgent response. For instance, a step 1410 may determine according to assessment 26 whether the current message is suspicious, and if yes, a further step 1412 may invoke communication module 39 to transmit message digest 22 to server 14.

If the input received by security agent 34 comprises a reply from server 14 (a step 1414 returns a YES), a step 1416 may analyze the respective security notification 24 to determine whether it is indicative of a computer security threat (e.g., online fraud). When YES, in a step 1418 agent 34 may mitigate the respective threat using any method known in the art. When the respective threat comprises online fraud, mitigation may include displaying a warning to the user, preventing the user from replying to the respective message, etc. When the threat includes malware, exemplary mitigation activities may include displaying a warning, preventing the user from accessing a link included in the respective message, preventing the installation of software on the respective client device, etc.

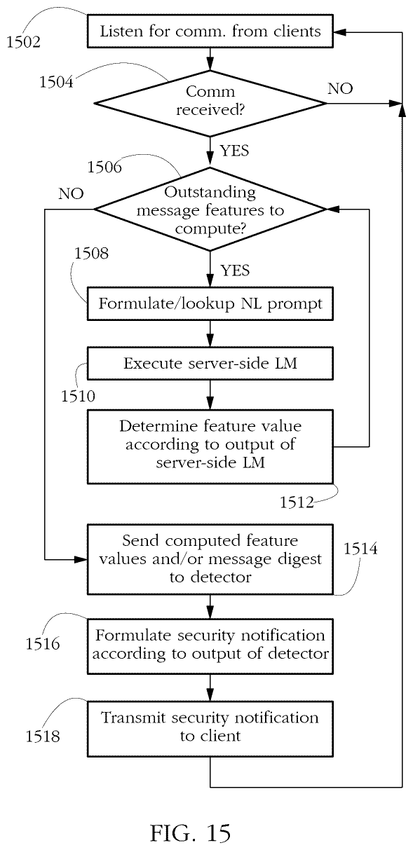

FIG. 15 shows an exemplary sequence of steps performed by the server-side security software (e.g., threat evaluator 135) according to some embodiments of the present invention. A sequence of steps 1502-1504 may listen for communications from client devices 12. As shown above, such communications may comprise message digests 22 characterizing NL messages 20 received by the respective clients. In some embodiments (see e.g., FIG. 7), message digest 22 includes a set of feature values fᵢ comprising values of various features of the respective message, features determined by the client-side feature extractor 36 as described above.

Some embodiments may employ server-side LM 240 to augment the received message digest with additional features, for instance higher-level, sophisticated features which cannot be reliably extracted by the substantially smaller client-side LM 140. A sequence of steps 1506-1508-1510-1512 may therefore be repeated for each additional feature value to be evaluated. Step 1508 may determine a feature-specific NL prompt 50, either by looking up prompt 50 into a repository (e.g., security knowledgebase 62 in FIG. 9) or by dynamically formulating the respective prompt. A step 1510 may then execute server-side LM 240 according to compact message embedding 147 and the current NL prompt. A further step 1512 may then determine the respective feature value according to the output of server-side LM 240.

When all additional message features have been evaluated, a step 1514 may transmit message digest 22 and the calculated additional feature values to detector 52 and execute detector 52 to produce security verdict 28 indicating whether the message represented by digest 22 exposes the user to a threat, e.g., online fraud. In a sequence of steps 1516-1518, server-side communication module 139 may formulate security notification 24 according to the output of detector 52 and selectively transmit notification 24 to the respective client device.

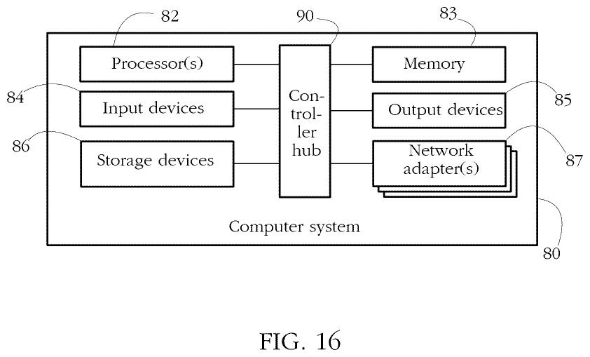

Computer security systems and methods as described above may be implemented as computer programs (software) executing on at least one hardware processor of a physical machine/computer system. However, a skilled artisan will know that at least some of the illustrated components may be implemented in dedicated hardware, such as a set of field-programmable gate arrays (FPGA) or application-specific integrated circuits (ASIC). FIG. 16 shows an exemplary hardware configuration of a computer system 80 programmed to execute some of the methods described herein. Computer system 80 generically represents client device 12 as well as security server 14, among others. The illustrated device is a personal computer; other devices such as mobile telephones, tablet computers, and wearables may have slightly different configurations.

Processor(s) 82 comprise a physical device (e.g. microprocessor, multi-core integrated circuit formed on a semiconductor substrate) configured to execute computational and/or logical operations with a set of signals and/or data. Such signals or data may be encoded and delivered to processor(s) 82 in the form of processor instructions, e.g., machine code.

Memory unit 83 may comprise volatile computer-readable media (e.g. dynamic random-access memory-DRAM) storing data/signals/instruction encodings accessed or generated by processor(s) 82 in the course of carrying out operations. Input devices 84 may include computer keyboards, mice, and microphones, among others, including the respective hardware interfaces and/or adapters allowing a user to introduce data and/or instructions into computer system 80. Output devices 85 may include display devices such as monitors and speakers among others, as well as hardware interfaces/adapters such as graphic cards, enabling the respective computing appliance to communicate data to a user. In some embodiments, input and output devices 84-85 share a common piece of hardware (e.g., a touch screen). Storage devices 86 include computer-readable media enabling the non-volatile storage, reading, and writing of software instructions and/or data. Exemplary storage devices include magnetic and optical disks and flash memory devices, as well as removable media such as CD and/or DVD disks and drives. Network adapter(s) 87 comprise specialized hardware that enable computer system 80 to connect to an electronic communication network and/or to other devices/computer systems for data transmission and reception.

Controller hub 90 generically represents the plurality of system, peripheral, and/or chipset buses, and/or all other circuitry enabling the communication between processor(s) 82 and the rest of the hardware components of computer system 80. For instance, controller hub 90 may comprise a memory controller, an input/output (I/O) controller, and an interrupt controller. Depending on hardware manufacturer, some such controllers may be incorporated into a single integrated circuit, and/or may be integrated with processor(s) 82. In another example, controller hub 90 may comprise a northbridge connecting processor 82 to memory 83, and/or a southbridge connecting processor 82 to devices 84, 85, 86, and 87.

The exemplary systems and methods described above enable efficiently protecting users against computer security threat such as online fraud and phishing, among others. Several anti-fraud systems and methods are known in the art. Security software may execute on the device that is used for messaging (e.g., a mobile telephone) and may analyze an incoming message to determine whether it poses a threat to the user. Alternatively, the received message may be transmitted to a remote security server for analysis.

Some conventional anti-fraud systems and methods determine whether a target message is fraudulent based on similarity with known fraudulent messages. Similarity is typically established according to a set of message features, such as specific keywords or phrases, a specific message layout, or the identity of the sender, among others. Recent anti-fraud technology increasingly relies on artificial intelligence, such as language models of various kinds, to extract more sophisticated message features for fraud detection.

However, the use of language models for fraud detection poses substantial challenges. The linguistic and semantic proficiency of LMs are known to increase dramatically with the size of the model. Meanwhile, training and operating large language models requires substantial computing resources, both in terms of processor cycles and memory. This severely restricts the ability of carrying out language model calculations on devices having relatively limited computing resources, such as mobile phones, tablet computers, wearables, and Internet of Things (IoT) devices. Consequently, typical anti-fraud methods relying on language models carry such calculation on a remote server. However, this requires transmitting a copy of the received message to the respective server, which creates a privacy concern.

Some embodiments of the present invention directly address such shortcomings, by dividing feature extraction activities, including language model calculations, between the client device and a remote security server. A relatively large LM executing on the server may receive an input computed by a much smaller LM executing on the client device. The client-side and server-side LMs may thus differ by orders of magnitude in size, for instance in the size of token representations and embeddings. The size of the client-side LM may be deliberately chosen to achieve a compromise between the computational cost or running and the level of linguistic and semantic proficiency of the respective model. Client devices having different computing capabilities may receive client-side LMs of different sizes.

In some embodiments, the client-side LM is used to calculate a compact message embedding characterizing a received message. The compact message embedding is then transmitted to the server, where it is inflated and fed to the server-side LM for processing. Crucially, in contrast to conventional anti-fraud methods, instead of sending the entire message for analysis to the server, embodiments of the present invention only send a message digest comprising a vector of numbers characterizing the respective message, thus ensuring the user's privacy.

In one exemplary embodiment, the compact embedding is inflated to the size of a server-side token representation of an individual token (e.g., an individual word) and fed to an encoder module of the server-side LM, the encoder module configured to receive token representations of a natural language prompt. In an alternative embodiment, the compact message embedding computed by the client-side LM is inflated to the size of the output of the server-side encoder module and then fed to a decoder module of the server-side LM.

In some embodiments, both the client- and server-side LM are used for feature extraction. Features extracted by the smaller, more naïve client-side LM are then augmented with more sophisticated, complex features on the server side. The complete set of features may then be used by a server-side detector to determine whether the respective message poses a threat.

Because only a message embedding computed by the client-side LM is transmitted to the server instead of the message per se, some embodiments explicitly ensure that information relevant to the task of the server-side LM is included in the respective message embedding. Some embodiments therefore pre-train the client-side LM on tasks assigned to the server-side LM, relying on the observation that such training is likely to instill task-specific information into the respective message embeddings. In one such example wherein server-side LM is tasked with identifying fraudulent messages, client-side LM is also trained to output a preliminary assessment indicating whether the received message is fraudulent.

It will be clear to one skilled in the art that the above embodiments may be altered in many ways without departing from the scope of the invention. Accordingly, the scope of the invention should be determined by the following claims and their legal equivalents.

1. A server computer system carrying out fraud detection activities on behalf of a plurality of client devices, the server computer system comprising at least one hardware processor configured to:
receive a compact message embedding from a client device of the plurality of client devices, the compact message embedding characterizing a natural language (NL) message received at the client device, the compact message embedding computed by a client-side language model (LM) pre-trained to identify fraudulent messages;
inflate the compact message embedding to produce an inflated embedding substantially larger than the compact message embedding;
input the inflated embedding to a selected component of a server-side LM executing on the server computer system, the server-side LM substantially larger than the client-side LM; and
determine whether the NL message is fraudulent according to an output of the server-side LM.

2. The computer system of claim 1, wherein the server-side LM comprises a tokenizer and an encoder configured to receive numerical representations of NL tokens from the tokenizer, and wherein the selected component comprises the encoder.

3. The computer system of claim 2, wherein the compact message embedding is inflated to a size of a numerical representation of an individual NL token.

4. The computer system of claim 1, wherein the server-side LM comprises a tokenizer, and encoder, and a decoder configured to receive from the encoder a prompt embedding comprising a vector of numbers collectively representing an NL prompt received by the server-side LM, and wherein the selected component comprises the encoder.

5. The computer system of claim 2, wherein the compact message embedding is inflated to a size of the prompt embedding.

6. The computer system of claim 2, wherein the inflated message embedding is combined with the prompt embedding before being fed to the decoder.

7. The computer system of claim 1, wherein inflating the compact message embedding comprises inserting dummy values at either end of the compact message embedding, or in between elements of the compact message embedding.

8. The computer system of claim 1, wherein inflating the compact message embedding comprises feeding the compact message embedding to a stack of neural network layers, wherein:
a count of neurons of an input layer of the stack matches a count of elements of the compact message embedding;
a count of neurons of the output layer of the stack substantially exceeds the count of neurons of the first layer of the stack; and
the stack is trained together with other components of the server-side LM.

9. The computer system of claim 1, wherein:
the compact message embedding comprises a first set of feature values comprising values of a first set of message attributes characterizing the NL message;
the server-side LM is configured to determine a second set of feature values comprising values of a second set of message attributes characterizing the NL message; and
the at least one hardware processor is configured to determine whether the NL message is fraudulent according to the first and second sets of feature values.

10. The computer system of claim 1, wherein the server-side LM is configured to determine a feature value comprising a value of a selected attribute of the NL message according to the compact message embedding received from the client device and further according to a NL prompt instructing the server-side LM to determine the feature value.

11. The computer system of claim 1, wherein the server-side LM is co-trained with the client-side LM to identify fraudulent messages, wherein co-training comprises:
employing the client-side LM to determine another compact message embedding characterizing a training message;
feeding the compact message embedding to the server-size LM; and
adjusting parameters of both the client-side LM and server-side LM according to an output of the server-side LM.

12. A method of detecting fraudulent messages using a server computer system connected to a plurality of client devices, the method comprising employing at least one hardware processor of the server computer system to:
receive a compact message embedding from a client device of the plurality of client devices, the compact message embedding characterizing a natural language (NL) message received at the client device, the compact message embedding computed by a client-side language model (LM) pre-trained to identify fraudulent messages;
inflate the compact message embedding to produce an inflated embedding substantially larger than the compact message embedding;
input the inflated embedding to a selected component of a server-side LM executing on the server computer system, the server-side LM substantially larger than the client-side LM; and
determine whether the NL message is fraudulent according to an output of the server-side LM.

13. The method of claim 12, wherein the server-side LM comprises a tokenizer and an encoder configured to receive numerical representations of NL tokens from the tokenizer, and wherein the selected component comprises the encoder.

14. The method of claim 13, wherein the compact message embedding is inflated to a size of a numerical representation of an individual NL token.

15. The method of claim 12, wherein the server-side LM comprises a tokenizer, and encoder, and a decoder configured to receive from the encoder a prompt embedding comprising a vector of numbers collectively representing an NL prompt received by the server-side LM, and wherein the selected component comprises the encoder.

16. The method of claim 15, wherein the compact message embedding is inflated to a size of the prompt embedding.

17. The method of claim 15, wherein the inflated message embedding is combined with the prompt embedding before being fed to the decoder.

18. The method of claim 12, wherein inflating the compact message embedding comprises inserting dummy values at either end of the compact message embedding, or in between elements of the compact message embedding.

19. The method of claim 12, wherein inflating the compact message embedding comprises feeding the compact message embedding to a stack of neural network layers, wherein:
a count of neurons of an input layer of the stack matches a count of elements of the compact message embedding;
a count of neurons of the output layer of the stack substantially exceeds the count of neurons of the first layer of the stack; and
the stack is trained together with other components of the server-side LM.

20. The method of claim 12, wherein:
the compact message embedding comprises a first set of feature values comprising values of a first set of message attributes characterizing the NL message;
the server-side LM is configured to determine a second set of feature values comprising values of a second set of message attributes characterizing the NL message; and
the method comprises employing the at least one hardware processor to determine whether the NL message is fraudulent according to the first and second sets of feature values.

21. The method of claim 12, wherein the server-side LM is configured to determine a feature value comprising a value of a selected attribute of the NL message according to the compact message embedding received from the client device and further according to a NL prompt instructing the server-side LM to determine the feature value.

22. The method of claim 12, wherein the server-side LM is co-trained with the client-side LM to identify fraudulent messages, wherein co-training comprises:
employing the client-side LM to determine another compact message embedding characterizing a training message;
feeding the compact message embedding to the server-size LM; and
adjusting parameters of both the client-side LM and server-side LM according to an output of the server-side LM.

23. A non-transitory computer-readable medium storing instructions which, when executed by at least one hardware processor of a server computer system connected to a plurality of client devices, cause the computer system to:
receive a compact message embedding from a client device of the plurality of client devices, the compact message embedding characterizing a natural language (NL) message received at the client device, the compact message embedding computed by a client-side language model (LM) pre-trained to identify fraudulent messages;
inflate the compact message embedding to produce an inflated embedding substantially larger than the compact message embedding;
input the inflated embedding to a selected component of a server-side LM executing on the server computer system, the server-side LM substantially larger than the client-side LM; and
determine whether the NL message is fraudulent according to an output of the server-side LM.
